(19) United States
(12) Patent Application Publication
(10) Pub. No.: US 2004/0036557 A1
(43) Pub. Date: Feb. 26, 2004

(54) Dielectric filter

(76) Inventors: Takehiko Yamakawa, Osaka (JP); Toru Yamada, Osaka (JP); Toshio Ishizaki, Hyogo (JP); Minoru Tachibana, Osaka (JP); Toshiaki Nakamura, Nara (JP)

Correspondence Address: Smith Gambrell & Russell, Suite 800, 1850 M Street NW, Washington, DC, 20036, US

(21) Appl. No.: 10/362,507

(22) PCT Filed: Aug. 27, 2001
(86) PCT No.: PCT/JP01/07303

(30) Foreign Application Priority Data
Aug. 29, 2000 (JP) 2000-259422

(51) Int. Cl. H01P 1/20

(52) U.S. Cl. 333/202; 333/230; 333/235

(57) ABSTRACT

To provide a strong input/output coupling while preventing a Q-value from deteriorating.

An input/output probe 110 is set on the upper face of a dielectric resonance element 106 so as to serve as a concentric circular arc of the dielectric resonance element 106. Moreover, the protrusion of an input/output-probe support 401 having a diameter equal to or slightly smaller than the diameter of the internal hole of the dielectric resonance element 106 is fitted into the internal hole of the dielectric resonance element 106 and the input/output-probe support 401 and an input/output-probe holder 402 are screwed with each other through the input/output probe 110. Thereby, it is possible to improve the coupling degree between the input/output probe 110 and dielectric resonator 106. Moreover, it is possible to improve the earthquake resistance and filter stability of the input/output probe 110.

### BACKGROUND OF THE INVENTION

1. Field of the Invention

The present invention relates to a dielectric filter used for a mobile communication base station for portable telephones and a broadcasting-radio-wave transmission station.

2. Background Art

A high-sensitivity transceiving performance and high communication quality have been recently indispensable for a portable telephone system, and a small-loss passing characteristic hardly deteriorating a signal component and a sharp attenuation characteristic capable of securely removing unnecessary disturbance-wave components are requested for a base-station filter. As a filter satisfying the above requests, there is a dielectric filter using a dielectric resonator having a high Q-value.

A conventional dielectric filter is described below by referring to the accompanying drawings. FIGS. 21(a) to 21(c) are block diagrams of a four-stage TE-mode band-pass filter. In the case of a filter of 480 MHz, the size of each cavity is approx. 160 mm in length and width and the diameter of a dielectric resonance element is 110 mm.

Four cavities are formed by a metallic case 2101, a metallic partition 2102, and a metallic lid 2103 which form a shield housing and dielectric resonance elements 2106 and 2107 are bonded to a case 2101 through supports 2104 and 2105 so that the elements 2106 and 2107 are respectively located at the center of a cavity.

An input/output port 2109 is set to the both ends of cavities continuously coupled through a coupling window 2108 formed by the gap between the partitions 2102 and the case 2101 and an input/output probe 2110 to be electromagnetic-field-coupled with the dielectric resonance element 2106 is set to internal conductors of the input/output port 2109 respectively.

The input/output-stage dielectric resonance element 2106 electromagnetic-field-couples with an inter-stage dielectric resonance element 2107 and inter-stage dielectric resonance elements 2107 electromagnetic-field-couple with each other through the coupling window 2108 respectively. The strength of each of the above couplings depends on the size of the window and is adjusted by making a coupling adjustment screw 2111 which extends vertically to the partition 2102 approach to or separate from the partition 2102. Moreover, a tuning plate 2112 constituted by a metallic screw and plate for adjusting a resonance frequency correspondingly to positions of the dielectric resonance elements 2106 and 2107 is set to the lid 2103.

A signal is input/output from 2109 and the input/output probe electromagnetic-field-couples with the input/output-stage dielectric resonance element 2106. The input/output-stage dielectric resonance element 2106 electromagnetic-field-couples with the inter-stage dielectric resonance element 2107 through the coupling window 2108 and the inter-stage dielectric resonance elements 2107 electromagnetic-field-couple with the coupling window 2108. The strength of each electromagnetic-field-coupling and the resonance frequency of each of the dielectric resonance elements 2106 and 2107 adjusted by the tuning plate 2112 are adjusted by a desired characteristic of a filter.

FIG. 22 is an enlarged view of the input/output probe 2110 and input/output-stage dielectric resonance element 2106. The input/output probe 2110 is set so as conform to the almost central height of the side face of the input/output-stage dielectric resonance element 2106.

To increase the strength of the coupling between the input/output probe 2110 and input/output-stage dielectric resonance element 2106, the length along the side face of the input/output-stage dielectric resonance element 2106 of the input/output probe 2110 is increased or the input/output probe 2110 is made to approach to the input/output-stage dielectric resonance element 2106.

However, in the case of the above configuration, the strength of the coupling between the input/output prove 2110 and input/output-stage dielectric resonance element 2106 is limited and moreover, there is a problem that the Q-value showing the performance of a resonator is deteriorated by increasing the length of the input/output probe 2110 or making the input/output prove 2110 approach to the input/output-stage dielectric resonance element 2106.

Moreover, there is a conventional problem that an input/output probe is not stably located at a predetermined position.

Furthermore, the above dielectric filter having the conventional configuration has a problem that a signal noise out of a desired frequency band has a large intensity.

Furthermore, the dielectric filter having the conventional configuration has a problem that discharge easily occurs when a high power is input.

Furthermore, there is a conventional problem that a dielectric resonator is not stably located at a predetermined position.

### DISCLOSURE OF THE INVENTION

The present invention is made to solve the above problems and its object is to provide a dielectric filter for increasing the coupling degree between an input/output probe and a dielectric resonator.

It is another object of the present invention to provide a dielectric filter including an input/output probe having a high earthquake resistance and stability.

It is still another object of the present invention to provide a dielectric filter that minimizes the intensity of noises out of a desired frequency band.

It is still another object of the present invention to provide a dielectric filter capable of preventing discharge from easily occurring when a high power is input.

It is still another object of the present invention to provide a dielectric filter including a dielectric resonator having a high earthquake resistance and stability.

To solve the above problem, a first invention of the present invention (corresponding to claim 1) is a dielectric filter comprising:

a dielectric resonator having a flat face;

an input/output probe electromagnetic-field-coupling with the dielectric resonator;

a metallic case for including the input/output probe and the dielectric resonator;

a lid; and

a tuning plate; wherein

the tuning plate and the flat face of the dielectric resonator are faced each other,

a part of the input/output probe is located between the dielectric resonator and the turning plate or between the metallic case at a portion of the dielectric resonator located at the opposite side to the turning plate and the dielectric resonator,

shapes of the dielectric resonators are cylindrical,

the flat faces of the cylindrical dielectric resonators and the tuning plate are faced each other, and

the shape of the input/output probe is a shape substantially along a predetermined concentric circular arc of the flat faces of the dielectric resonators.

A second invention of the present invention (corresponding to claim 2) is a dielectric filter comprising:

a metallic case;

a lid;

a metallic partition for partitioning the inside of the metallic case into a plurality of spaces;

a plurality of dielectric resonators arranged in the partitioned spaces one each and respectively having a flat face;

a turning plate; and

an input/output probe; wherein

the tuning plate and the flat faces of the dielectric resonators are faced each other,

a part of the input/output probe is located between the dielectric resonators and the turning plate or between the metallic case at a portion of the dielectric resonators located at the opposite side to the turning plate and the dielectric resonators,

a coupling window is formed between the metallic case and the partition in a face substantially including the partition,

a coupling adjustment screw for fine-adjusting the coupling degree between adjacent dielectric resonators coupled through the coupling window is further included, and

a part of the coupling adjustment screw is located at the coupling window.

A fifth invention of the present invention (corresponding to claim 5) is the dielectric filter according to any one of the first to the second inventions, wherein

the input/output probe is mechanically fixed to the dielectric resonators on the flat faces of them.

A sixth invention of the present invention (corresponding to claim 6) is a dielectric filter comprising:

a metallic case;

a lid;

a metallic partition for partitioning the inside of the metallic case into a plurality of spaces;

a plurality of dielectric resonators arranged in the partitioned spaces and respectively having a flat face;

a tuning plate;

an input/output probe; and

a plurality of transmission lines connected in series between an input terminal and an output terminal; wherein

the tuning plate and the flat faces of the dielectric resonators are faced each other,

a part of the input/output probe is located between the dielectric resonators and the tuning plate or between the metallic case at a portion of the dielectric resonators located at the opposite side to the tuning plate and the dielectric resonators,

one end of the input/output probe is connected to each connection point of the plurality of transmission lines, and

the other end of the input/output probe is fixed to the flat faces of the dielectric resonators by an insulating adhesive.

A seventh invention of the present invention (corresponding to claim 7) is the dielectric filter according to the fifth invention, comprising:

a flat input/output-probe support formed by a low-dielectric-constant material or insulating material and having a cylindrical protrusion; and

an input/output-probe holder formed by a low-dielectric-constant material or insulating material; wherein

the dielectric resonators are respectively provided with an internal hole into which the protrusion is fitted, and

the input/output probe is held and fixed by the input/output-probe support fixed by the protrusion being fitted into the internal hole of each of the dielectric resonators and the input/output-probe holder.

An eighth invention of the present invention (corresponding to claim 8) is a dielectric filter comprising:

an input/output probe;

a dielectric resonator; and

a metallic case including the input/output probe and the dielectric resonator; wherein

at least a part of the input/output probe is mechanically fixed to the dielectric resonator.

A ninth invention of the present invention (corresponding to claim 9) is a dielectric filter comprising:

a metallic case;

a lid;

a metallic partition for partitioning the inside of the metallic case into a plurality of spaces;

a plurality of dielectric resonators arranged in the partitioned spaces; and

an input/output probe; wherein

a coupling window is formed between the metallic case and the partition in a face substantially including the partition,

a coupling adjustment screw for fine-adjusting the coupling degree between the adjacent dielectric resonators coupled through the coupling window is further included, and

a part of the coupling adjustment screw is located at the coupling window and moreover, the top of the coupling adjustment screw is covered with a low-dielectric-constant material.

A tenth invention of the present invention (corresponding to claim 10) is the dielectric filter according to the ninth invention, wherein

a plurality of the coupling adjustment screw s are used.

An eleventh invention of the present invention (corresponding to claim 11) is a dielectric filter comprising:

an input/output probe;

a dielectric resonator; and

a metallic case including the input/output probe and the dielectric resonator; wherein

at least a part of the input/output probe is separated from the metallic case by a substantially equal distance

the dielectric resonator has two flat faces opposite to each other, and

the position of the input/output probe is present at the lateral side of the dielectric resonator between lower flat face and the upper flat face of the dielectric resonator.

A twelfth invention of the present invention (corresponding to claim 12) is a dielectric filter comprising:

a metallic case;

a metallic partition for partitioning the inside of the metallic case into a plurality of spaces;

a plurality of dielectric resonators arranged in the partitioned spaces; and

an input/output probe; wherein

at least a part of the input/output probe is separated from the partition by a substantially equal distance, and

the position of the input/output probe is present at the lateral side of the dielectric resonator between lower flat face and the upper flat face of the dielectric resonator.

A thirteenth invention of the present invention (corresponding to claim 13) is the dielectric filter according to the eleventh or the twelfth invention, wherein

a member formed by a low-dielectric-constant material is provided between the input/output probe and the metallic case or between the input/output probe and the partition.

A fourteenth invention of the present invention (corresponding to claim 14) is the dielectric filter according to the eleventh or the twelfth invention, wherein

a portion of the input/output probe separated from the metallic case by a substantially equal distance or a portion of the input/output probe separated from the partition by a substantially equal distance is covered with a low-dielectric-constant material.

A fifteenth invention of the present invention (corresponding to claim 15) is the dielectric filter according to the eleventh or the twelfth invention, wherein

the front end of the input/output probe is folded like a loop.

A sixteenth invention of the present invention (corresponding to claim 16) is the dielectric filter according to the eleventh or the twelfth invention, wherein

the front end of the input/output probe is rounded through soldering.

A seventeenth invention of the present invention (corresponding to claim 17) is the dielectric filter according to the eleventh or the twelfth invention, wherein

the front end of the input/output probe is covered with a cap made of a low-dielectric-constant material.

An eighteenth invention of the present invention (corresponding to claim 18) is a dielectric filter comprising:

an input/output port;

an input/output probe;

a dielectric resonator; and

a metallic case including the input/output probe and the dielectric resonator; wherein

the input/output probe is formed by two metal wires arranged so that the input/output probe keeps a substantially parallel relation,

front ends of the two metal wires are connected so as to be rounded, and

one of the two metal wires is connected with the input/output port and the other of them is grounded to the metallic case.

A nineteenth invention of the present invention (corresponding to claim 19) is a dielectric filter comprising:

an input/output probe;

a dielectric resonator;

a dielectric-resonator support for supporting the dielectric resonator;

a dielectric-resonator-fixing member for fixing the dielectric resonator formed by a low-dielectric-constant material; and

a metallic case including the input/output probe and the dielectric resonator, wherein

the lower face of the dielectric resonator connects with the metallic case through the dielectric-resonator support, and

the dielectric-resonance is fixed to the upper face of the dielectric resonator by the dielectric-resonator-fixing member.

A twentieth invention of the present invention (Corresponding to claim 20) is the dielectric filter according to the nineteenth invention, wherein the dielectric-resonator-fixing member is constituted by two support rods arranged so as to form a cross on the upper face of the dielectric resonator and four support-rod holders for fixing the both ends of the support rods to the metallic case.

A twenty-first invention of the present invention (corresponding to claim 21) is the dielectric filter according to the twentieth invention, wherein

the dielectric resonator has a predetermined internal hole, and

one of the support rods has a protrusion fitted into the internal hole and the protrusion is fitted into the internal hole and the above one support rod is integrated with the dielectric resonator.

A twenty-second invention of the present invention (corresponding to claim 22) is a transceiving system comprising:

the dielectric filter of any one of the first, the second and the fifth to the twenty-first inventions;

a receiving circuit;

a transmitting circuit; and

an antenna.

### BRIEF DESCRIPTION OF THE DRAWINGS

FIG. 1(a) is a top view of a dielectric filter of embodiment 1 of the present invention;

FIG. 1(b) is a perspective view of a lid of the dielectric filter of the embodiment 1 of the present invention;

FIG. 1(c) is a sectional view of the dielectric filter of the embodiment 1 of the present invention;

FIG. 2 is a sectional view of a coupling window of the dielectric filter of the embodiment 1 of the present invention;

FIG. 3 is a local perspective view of an input/output coupling portion of the dielectric filter of the embodiment 1 of the present invention;

FIG. 4(a) is an exploded perspective view of an input/output-probe support and holder of the dielectric filter of the embodiment 1 of the present invention;

FIG. 4(b) is a perspective view of the input/output probe support and holder of the dielectric filter of the embodiment 1 of the present invention;

FIG. 5(a) is a top view of a dielectric filter of embodiment 2 of the present invention;

FIG. 5(b) is an exploded perspective view of an input/output coupling portion of the dielectric filter of the embodiment 2 of the present invention;

FIG. 6 is an illustration showing a transfer characteristic of the dielectric filter of the embodiment 2 of the present invention;

FIG. 7(a) is a top view of the dielectric filter of the embodiment 2 of the present invention;

FIG. 7(b) is an exploded perspective view of an input/output coupling portion of the dielectric filter of the embodiment 2 of the present invention;

FIG. 8(a) is a top view of a dielectric filter of embodiment 3 of the present invention;

FIG. 8(b) is an exploded perspective view of an input/output coupling portion of the dielectric filter of the embodiment 3 of the present invention;

FIG. 9 is an enlargement view of the front end of an input/output probe of a dielectric filter of embodiment 4 of the present invention;

FIG. 10 is an enlargement view of the front end of the input/output probe of the dielectric filter of the embodiment 4 of the present invention;

FIG. 11 is an enlargement view of the front end of the input/output probe of the dielectric filter of the embodiment 4 of the present invention;

FIGS. 12(a) and 12(b) are exploded perspective views of an input/output coupling portion of a dielectric filter of embodiment 5 of the present invention;

FIG. 13 is a perspective view of a dielectric resonator of embodiment 6 of the present invention;

FIG. 14(a) is a perspective view of a dielectric filter of embodiment 7 of the present invention;

FIG. 14(b) is a top view of a transmission line portion of the dielectric filter of the embodiment 7 of the present invention;

FIG. 15 is an exploded perspective view of an input/output coupling portion of the dielectric filter of the embodiment 7 of the present invention;

FIG. 16(a) is an exploded perspective view of an input/output probe support and holder of the dielectric filter of the embodiment 7 of the present invention;

FIG. 16(b) is a perspective view of the input/output probe support and holder of the dielectric filter of the embodiment 7 of the present invention;

FIG. 17 is an exploded perspective view of an input/output coupling portion of the dielectric filter of the embodiment 7 of the present invention;

FIG. 18 is an exploded perspective view of the input/output coupling portion of the dielectric filter of the embodiment 7 of the present invention;

FIG. 19 is an exploded perspective view of the input/output coupling portion of the dielectric filter of the embodiment 7 of the present invention;

FIG. 20 is a perspective view of a dielectric resonator of the dielectric filter of the embodiment 7 of the present invention;

FIG. 21(a) is a top view of a conventional dielectric filter;

FIG. 21(b) is a perspective view of a lid of the conventional dielectric filter;

FIG. 21(c) is a sectional view of the conventional dielectric filter; and

FIG. 22 is an exploded perspective view of an input/output coupling portion of the conventional dielectric filter.

[Description of Symbols]

101 Case

102 Partition

103 Lid

104 Input/output-stage support

105 Inter-stage support

106 Input/output-stage dielectric resonance element

107 Inter-stage dielectric resonance element

108 Coupling window

109 Input/output port

110 Input/output probe

111 Coupling adjustment screw

112 Tuning plate

113 Adjustment screw coat

114 Input/output-probe-fixing adhesive

401 Input/output probe support

402 Input/output probe holder

403 Bolt

501 Input/output probe

801 Input/output probe coat

1001 Solder cap

1101 Teflon cap

1201 Input/output probe

1301 Dielectric-resonance-element holder

1302 Dielectric-resonance-element-holder hardware

1401 Cavity

1402 Transmission line case

1403 Lid

1404 Transmission line

1405 Input/output port

1406 Dielectric resonance element

1407 Input/output probe

1408 Support

1409 Tuning plate

1501 .Input/output probe

1502 Input/output-probe-fixing adhesive

1601 Input/output probe support

1602 Input/output probe holder

1603 Bolt

1701 Input/output probe

1801 Input/output probe coat

1901 Input/output probe

2001 Dielectric resonance element holder

2002 Dielectric-resonance-element-holder hardware

2101 Case

2102 Partition

2103 Lid

2104 Input/output stage support

2105 .Inter-stage support

2106 Input/output-stage dielectric resonance element

2107 Inter-stage dielectric resonance element

2108 Coupling window

2109 Input/output port

2110 Input/output probe

2111 Coupling adjustment screw

2112 Tuning plate

### BEST MODE FOR CARRYING OUT THE INVENTION

A dielectric filter of an embodiment of the present invention is described below by referring to the accompanying drawings.

(Embodiment 1)

First, the dielectric filter of the embodiment 1 of the present invention is described by referring to the accompanying drawings.

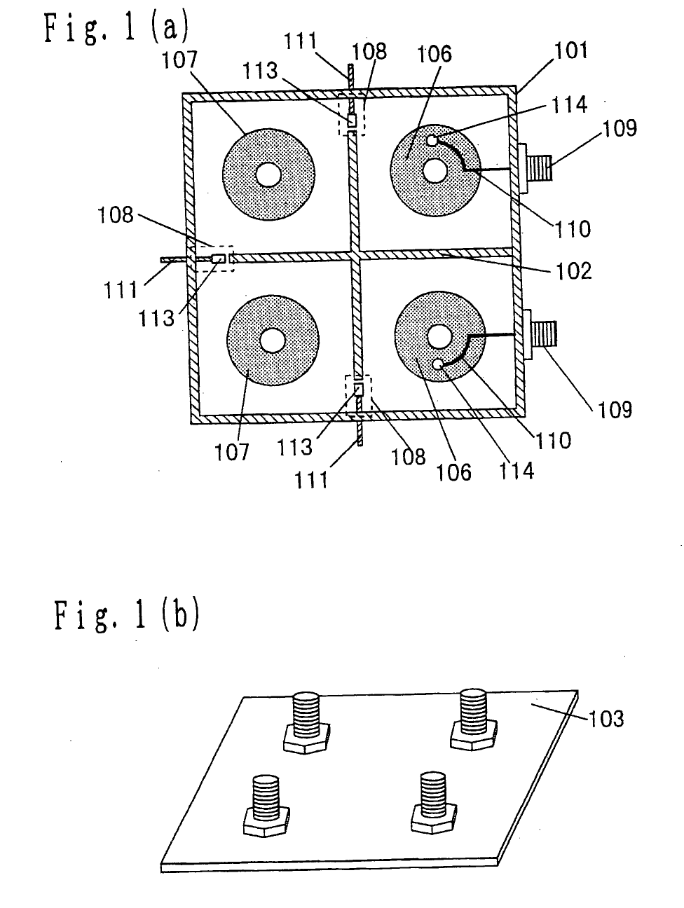

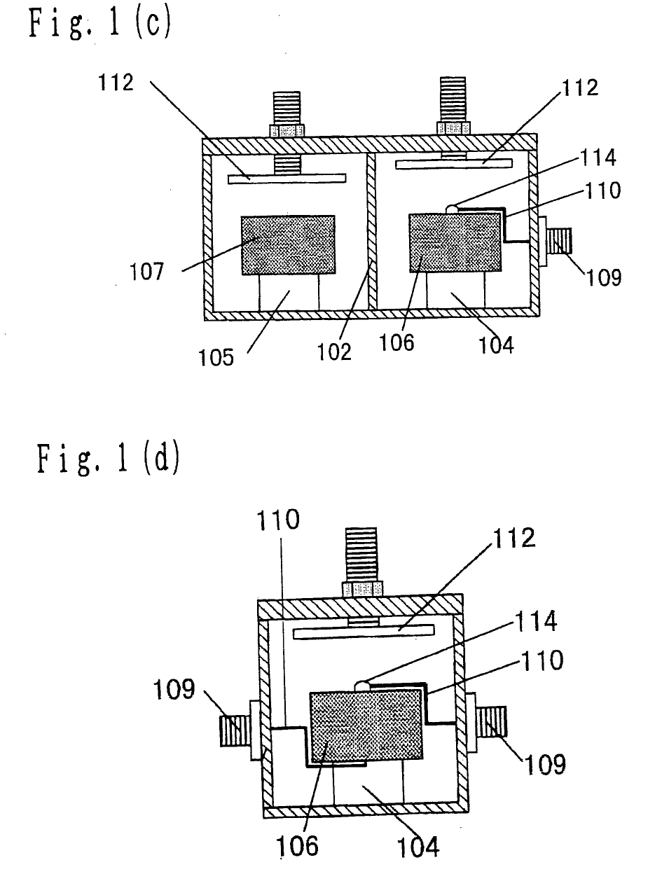

FIGS. 1(a) to 1(d) show a four-stage TE-mode band-pass filter of the embodiment 1 of the present invention, in which FIG. 1(a) is a top view, FIG. 1(b) is a perspective view of a lid, and FIG. 1(c) is a longitudinal sectional view, and FIG. 1(d) is a longitudinal sectional view when one dielectric resonator is used.

In FIGS. 1(a) to 1(d), symbol 101 denotes a case, 102 denotes a partition, 103 denotes a lid, 104 denotes an input/output-stage support, 105 denotes an inter-stage support, 106 denotes an input/output-stage dielectric resonance element, 107 denotes an inter-stage dielectric resonance element, 108 denotes a coupling window, 109 denotes an input/output port, 110 denotes an input/output probe, 111 denotes a coupling adjustment screw, 112 denotes a tuning plate, 113 denotes an adjustment screw coat, and 114 denotes an input/output-probe-fixing adhesive.

Four cavities are formed by the metallic case 101, metallic partition 102, and metallic lid 103 and the input/output-stage dielectric resonance element 106 and inter-stage dielectric resonance element 107 are bonded to the case 101 through the input/output-stage support 104 and inter-stage support 105 respectively so as to be located at almost the center of each cavity.

The input/output port 109 is set to the both ends of cavities continuously coupled through the partitions 102 between the cavities and the coupling windows 108 formed of the gaps in the case 101, each cavity being partitioned with the metallic case 101, metallic partition 102, and metallic lid 103, and the input/output probe 110 to be electromagnetic-field-coupled with the input/output-stage dielectric resonance element 106 is set to the internal conductor of each of the input/output port 109.

The front end of the input/output probe 110 is fixed to the input/output-stage dielectric resonance element 106 by the input/output-probe-fixing adhesive 114. An input/output stage is a cavity provided for an input/output port and the gap between stages denotes a cavity located between cavities of input/output stages.

The input/output-stage dielectric resonance element 106 electromagnetic-field-couples with the inter-stage dielectric resonance element 107 and the inter-stage dielectric resonance elements 107 electromagnetic-field-couple with each other respectively through the coupling window 108. The strength of each coupling depends on the size of the window and is adjusted by making the coupling adjustment screw 111 extending vertically to the partition 102 threaded to the case 101 approach to or separate from the partition 102.

Moreover, the tuning plate 112 constituted by a metallic screw and plate for adjusting a resonance frequency is set to the lid 103 corresponding to positions of the input/output-stage dielectric resonance element 106 and inter-stage dielectric resonance element 107.

Operations of the four-stage TE-mode band-pass filter constituted as described above are described below.

A signal is input/output from 109 and the input/output probe 110 electromagnetic-field-couples with the input/output-stage dielectric resonance element 106. The input/output-stage dielectric resonance element 106 electromagnetic-field-couples with the inter-stage dielectric resonance element 107 through the coupling window 108 and the inter-stage dielectric resonance elements 107 electromagnetic-field-couple with each other through the coupling window 108. A desired band-pass characteristic is realized by adjusting the strength of each electromagnetic-field-coupling and resonance frequencies of each input/output-stage dielectric resonance element 106 and inter-stage dielectric resonance element 107, each frequency being adjusted by the tuning plate 112.

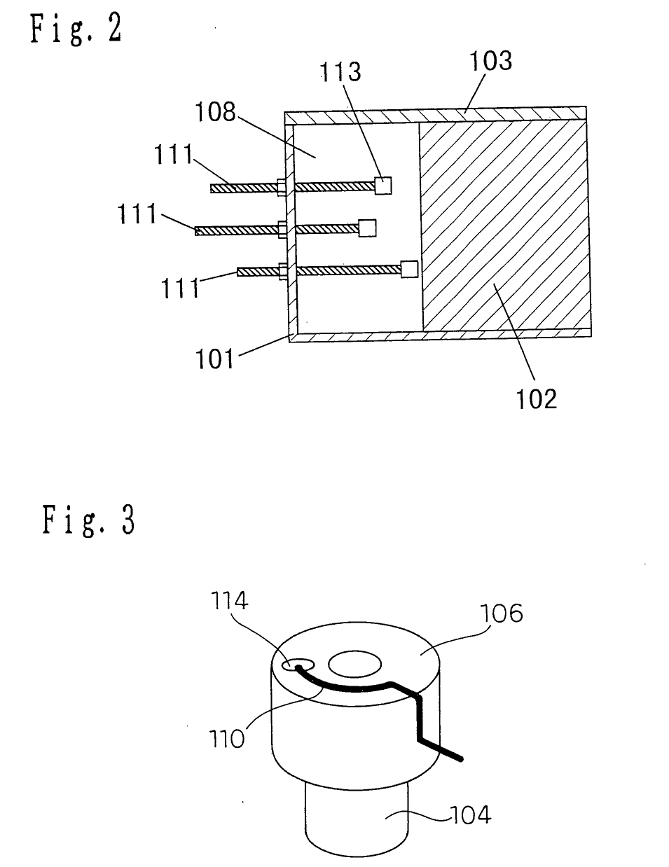

FIG. 2 is a sectional view of the coupling window 108. Three coupling adjustment screw s 111 are inserted vertically to the partition 102. In comparison with the case of using one adjustment screw 111, the number of adjustment portions increases, the coupling adjustment width can be increased, and the adjustment time is reduced. The adjustment screw coat 113 is made of a low-dielectric-constant material having a high Q-value such as Teflon and is tapped at a diameter equal to or less than that of the coupling adjustment screw 111. By setting the adjustment screw coat 113 to the top of the coupling adjustment screw 111, it is possible to prevent the coupling adjustment screw 111 from short-circuiting with the partition 102 and the discharge breakdown when a high power is input.

FIG. 3 is an enlargement perspective view of the input/output-stage input/output probe 110 and input/output-stage dielectric resonance element 106. The input/output probe 110 is set on the upper face of the input/output-stage dielectric resonance element 106 so as to form a circular arc concentric with the input/output-stage dielectric resonance element 106. This is set so as not to cross the equipotential surface of the input/output-stage dielectric resonance element 106 and thereby it is possible to efficiently obtain a strong coupling.

The front end of the input/output probe 110 is fixed to the input/output-stage dielectric resonance element 106 by the input/output-probe-fixing adhesive 114 and thereby, the earthquake resistance of the input/output probe 110 and the stability of a filter are improved. That is, by setting the input/output probe 110 on the flat face of a resonator, it is possible to easily keep the interval between the input/output-stage dielectric resonance element 106 and input/output probe 110.

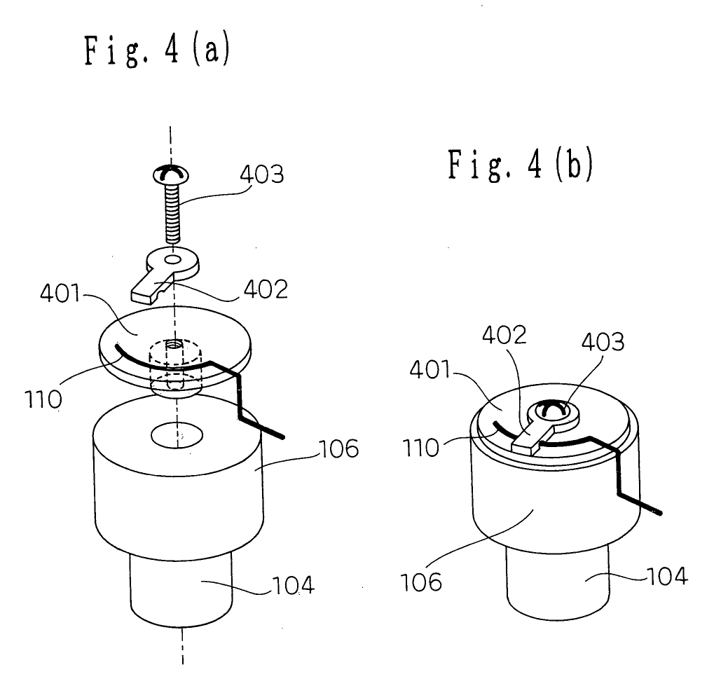

As the method of fixing the input/output probe 110, also by fixing with a low-dielectric-constant material such as Teflon having a high Q-value or an insulating material as shown in FIG. 4, it is possible to obtain the same earthquake resistance and filter stability.

The protrusion of the input/output probe support 401, whose diameter is equal to or slightly smaller than the inside diameter of the input/output-stage dielectric resonance element 106, is fitted into the internal hole of the input/output-stage dielectric resonance element 106. In this case, the difference between the inside diameter of the input/output-stage dielectric resonance element 106 and the outside diameter of the protrusion of the input/output-probe support 401 is minimized so that the input/output-probe support 401 is not removed from the input/output-stage dielectric resonance element 106.

The input/output-probe support 401 and input/output-probe holder 402 are fixed by extending the input/output probe 110 on the input/output-probe support 401 and holding the input/output probe 110 by the input/output-probe holder 402 from the top of the input/output probe 110, and fixing the input/output-probe support 401 and input/output-probe holder 402 with the bolt 403. It is possible to realize a small-loss filter in which the Q-value of a resonator is hardly deteriorated by using a nonmetallic material such as Teflon or plastic having a high Q-value for the input/output-probe support 401, input/output-probe holder 402, and bolt 403. Moreover, the input/output-probe support 401 is tapped so that it can be fastened by the bolt 403.

Though the input/output probe 110 is set on the input/output-stage dielectric resonance element 106 clockwise, it is also allowed to set it counterclockwise. Moreover, it is allowed that the probes 110 are set on the input/output-stage dielectric resonance elements 106 opposite to each other.

Though the above embodiment is described by assuming that a dielectric resonance element is cylindrical, the dielectric resonance element is not restricted to be cylindrical. Also in the case of not being cylindrical, by setting a part of an input/output probe between a tuning plate and a dielectric resonance element, the electromagnetic-field-coupling between the dielectric resonance element and input/output probe becomes stronger than ever.

Moreover, in the case of the above embodiment, a part of an input/output probe is located between the flat face of a cylindrical dielectric resonance element not contacting with a support and a tuning plate. However, it is also allowed that a part of the input/output probe is located between the flat face of the dielectric resonance element contacting with the support and a case.

In short, it is allowed that apart of an input/output probe is located between a dielectric resonance element and a turning plate or located between the case at a portion located at the opposite side to a tuning plate and the dielectric resonance element.

(Embodiment 2)

Then, the embodiment 2 of the present invention is described below by referring to the accompanying drawings.

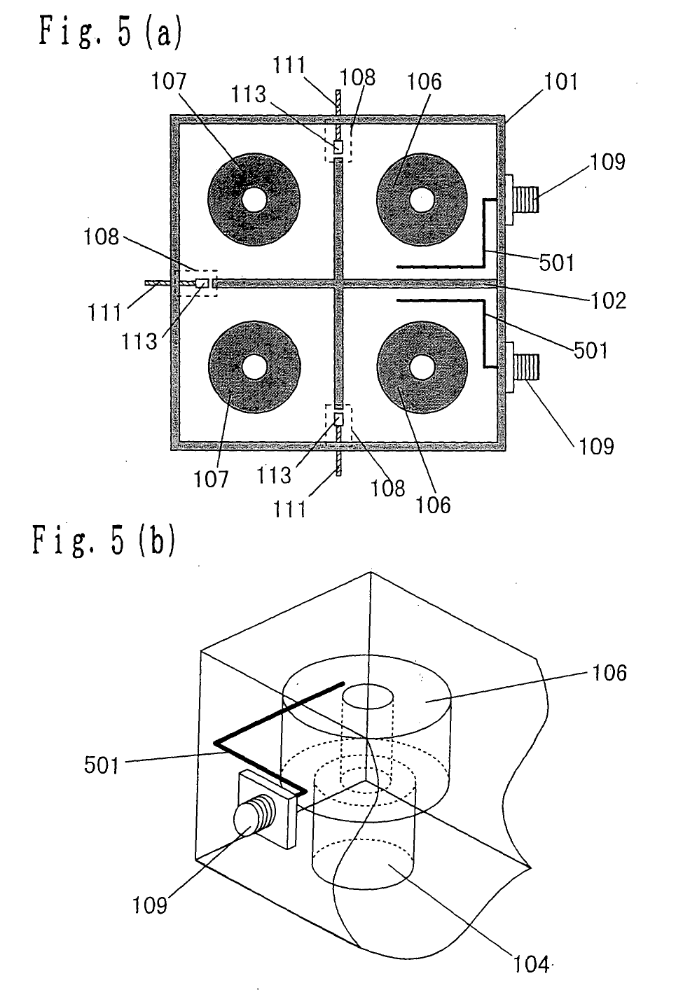

FIGS. 5(a) and 5(b) show the four-stage TE-mode band-pass filter of the embodiment 2 of the present invention. In FIGS. 5(a) and 5(b), symbol 501 denotes an input/output probe and the same portion as that in FIG. 1 is provided with the same symbol. The embodiment 2 and the embodiment 1 differ in the form of the input/output probe 501, where the input/output probe 501 connected with the internal conductor of the input/output port 109 is L-shaped along a case 101 and partition 102 at a height nearby the center of thickness of an input/output-stage dielectric resonance element 106.

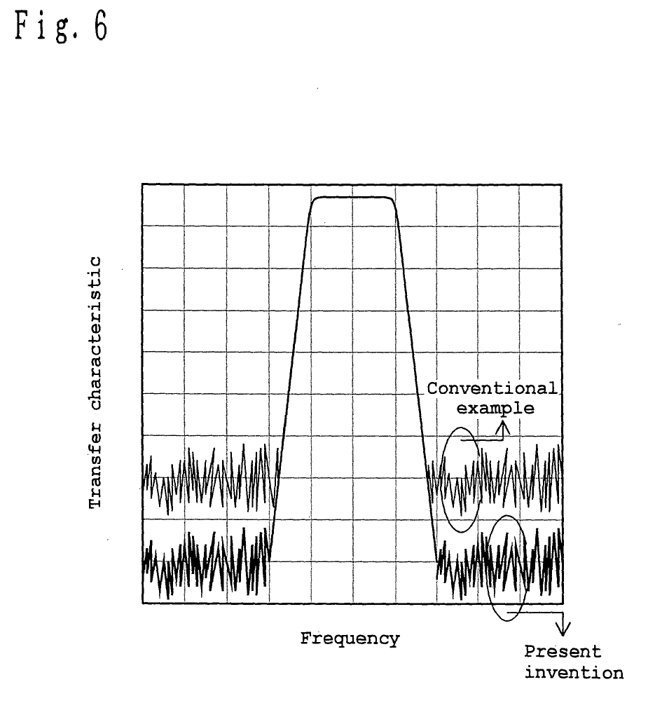

By forming the input/output probe 501 into an L shape, a capacity is formed between the case 101, that is, the ground and the input/output probe 501. By adjusting the capacity, it is possible to easily adjust the coupling with the input/output-stage dielectric resonance element 106 and resultantly easily obtain a strong coupling. Moreover, the capacity of a bypass is formed between grounds and it is possible to lower the background out of a frequency band as shown in FIG. 6.

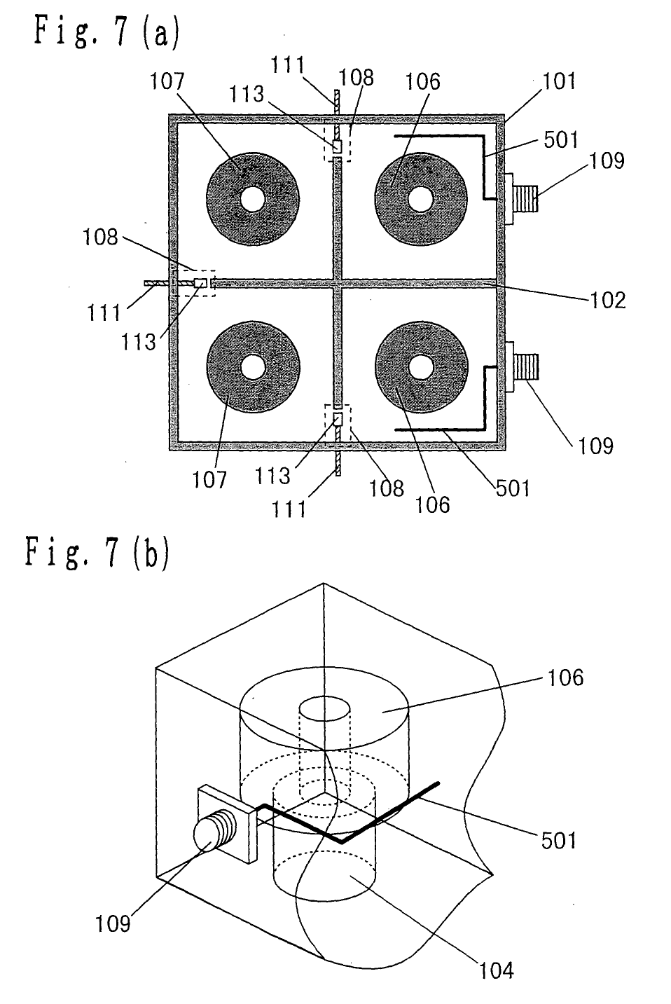

Though the input/output probe 501 has been set along the case 101 and partition 102, it is also allowed to set the probe 501 along the case 101 as shown in FIG. 7.

Moreover, it is allowed to set one input/output probe 501 along the case 101 and partition 102 as shown in FIG. 5 and set the other input/output probe 501 along the case 101 as shown in FIG. 7.

Though the above embodiment is described by assuming that the case 101 is rectangular parallelepiped, the case 101 is not restricted to be rectangular parallelepiped as shown in FIG. 5 and FIG. 7. It is allowed that the case 101 is cylindrical. Also in this case, by setting an input/output probe so that a portion of the probe having a predetermined length is separated from the case by a substantially equal distance, a capacity is formed between the input/output probe and the case and it is possible to lower the background out of a frequency band.

Similarly, in the embodiment described above, the shape of the partition is not limited to the flat plate shape, but may also be a curved plate shape. Even in the latter case, when a predetermined length of portion of the input/output probe is spaced with substantially even distances from the partition, a capacity is formed between the input/output probe and the partition, and it is possible to lower the background out of a frequency band.

(Embodiment 3)

Then, the embodiment 3 of the present invention is described below.

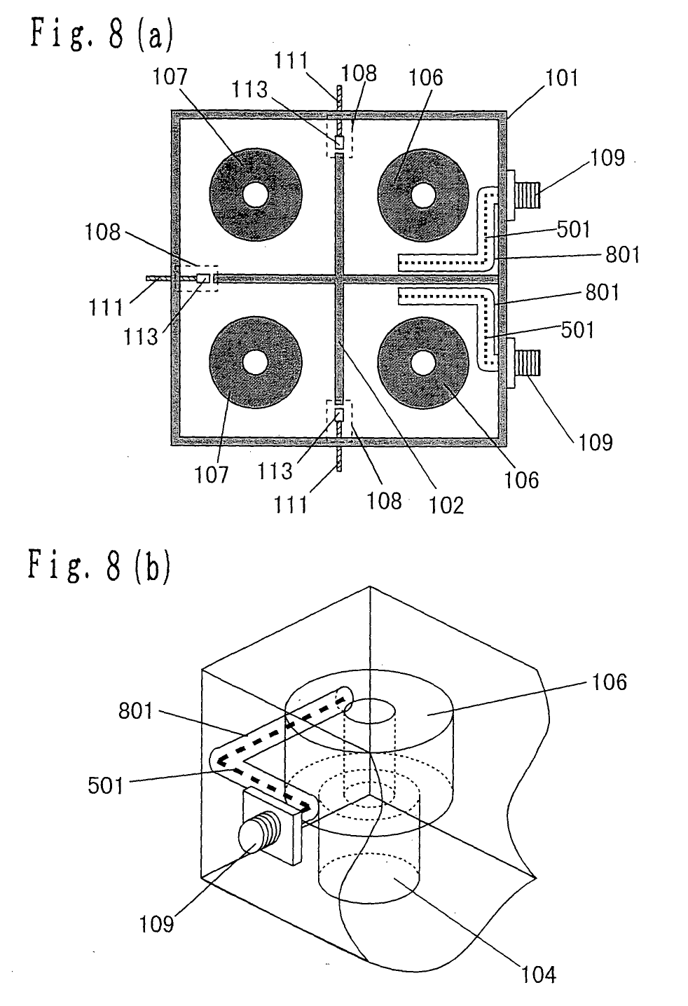

FIGS. 8(a) and 8(b) show the four-stage TE-mode band-pass filter of the embodiment 3. In FIGS. 8(a) and 8(b), symbol 801 denotes an input/output probe coat, and the same portion as that in FIG. 5 is provided with the same symbol. The embodiment 3 is different from the embodiment 2 in that an input/output probe 501 is covered with a low-dielectric-constant material having a high Q-value such as Teflon. By forming an input/output-prove coat 801 between the input/output probe 501 and the case 101 serving as the ground, it is possible to prevent discharge breakdown when a high power is input.

Also in the case of this embodiment, it is allowed to reverse at least either direction of the input/output probe 501 viewed from the top the same as the case of the embodiment 2.

Moreover, in the case of this embodiment, the input/output-prove-coat 801 surrounds the input/output probe 501. However, it is allowed to form the input/output-probe coat 801 only between the input/output probe 501 and the case 101 serving as the ground.

Furthermore, by setting a member made of a low-dielectric-constant material having a high Q-value between an input/output probe and a case and/or between the input/output probe and a partition, it is possible to prevent discharge breakdown when a high power is input.

(Embodiment 4)

Then, the embodiment 4 of the present invention is described below by referring to the accompanying drawings.

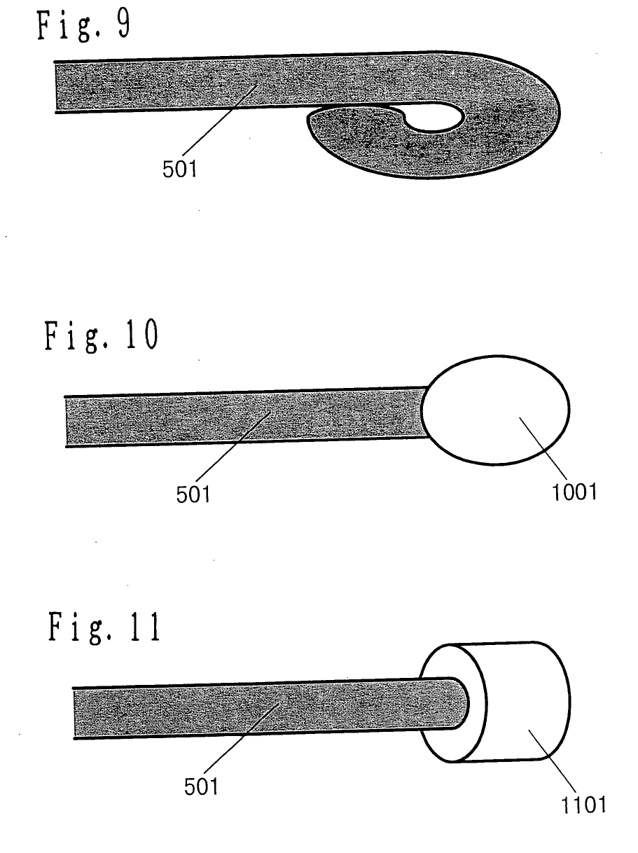

FIGS. 9, 10, and 11 show the front end of an input/output probe of the four-stage TE-mode band-pass filter of the embodiment 4. A portion same as that in FIG. 5 is provided with the same symbol. In FIGS. 9, 10, and 11, symbol 1001 denotes a solder cap and 1101 denotes a Teflon cap. The embodiment 4 is different from the embodiment 2 in the shape of the front end of an input/output probe 501. By folding the front end of the input/output probe 501 as shown in FIG. 9, soldering the front end of the input/output probe 501 so as to be rounded as shown in FIG. 10, or covering the front end of the input/output probe 501 with a low-dielectric-constant material having a high Q-value such as Teflon as shown in FIG. 11, discharge can be prevented from easily occurring when a high power is input.

(Embodiment 5)

Then, the embodiment 5 of the present invention is described below by referring to the accompanying drawings.

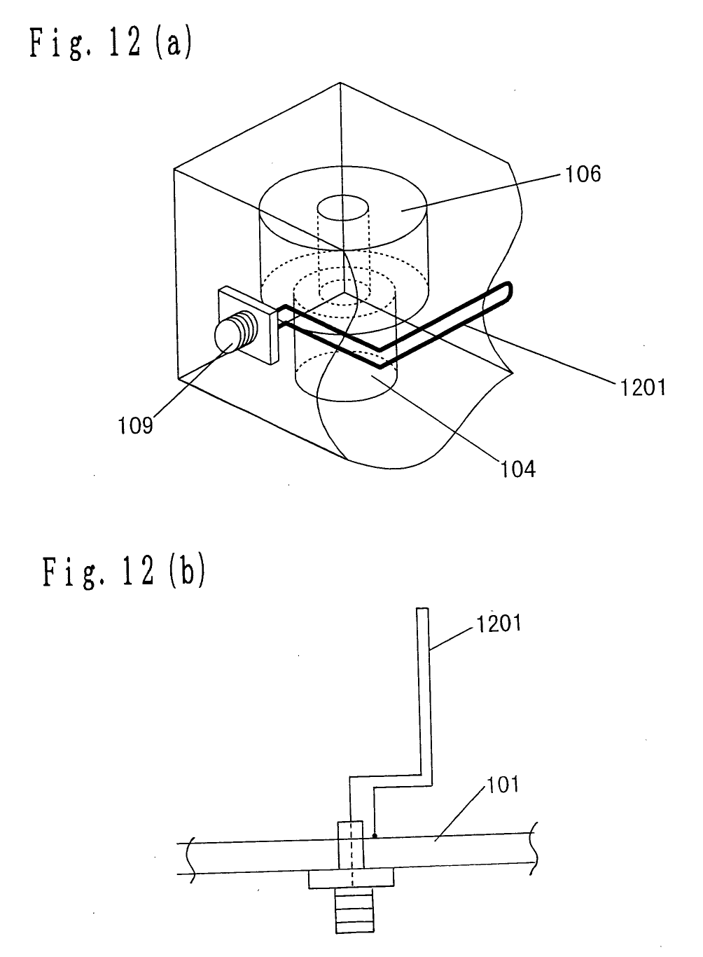

FIG. 12(a) shows the shape of an input/output probe of the four-stage TE-mode band-pass filter of the embodiment 5 of the present invention. A portion same as that in FIG. 5 is provided with the dame symbol. In FIG. 12(a), symbol 1201 denotes an input/output probe. In the case of the input/output probe 1201, the front end is short-circuited by almost doubling the input/output probe with the front end open of the conventional example, embodiment 1, or embodiment 2, folding the input/output probe at the front end of the conventional example, embodiment 1, or embodiment 2, setting the input/output probe so as to extend along the input/output probe up to the folding portion at the front end of the conventional example, embodiment 1, or embodiment 2, and the input/output port 109, and connecting the front end of the input/output probe near the input/output port 109. Thereby, the front end of the input/output probe on which current is most concentrated when a high power is input is rounded to prevent discharge breakdown (refer to FIG. 12(b)).

(Embodiment 6)

Then, the embodiment 6 of the present invention is described below by referring to the accompanying drawings.

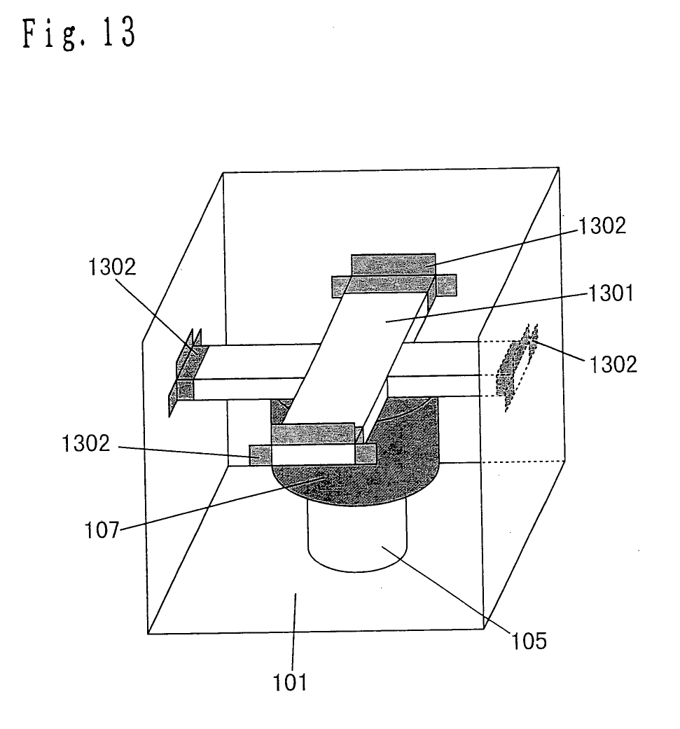

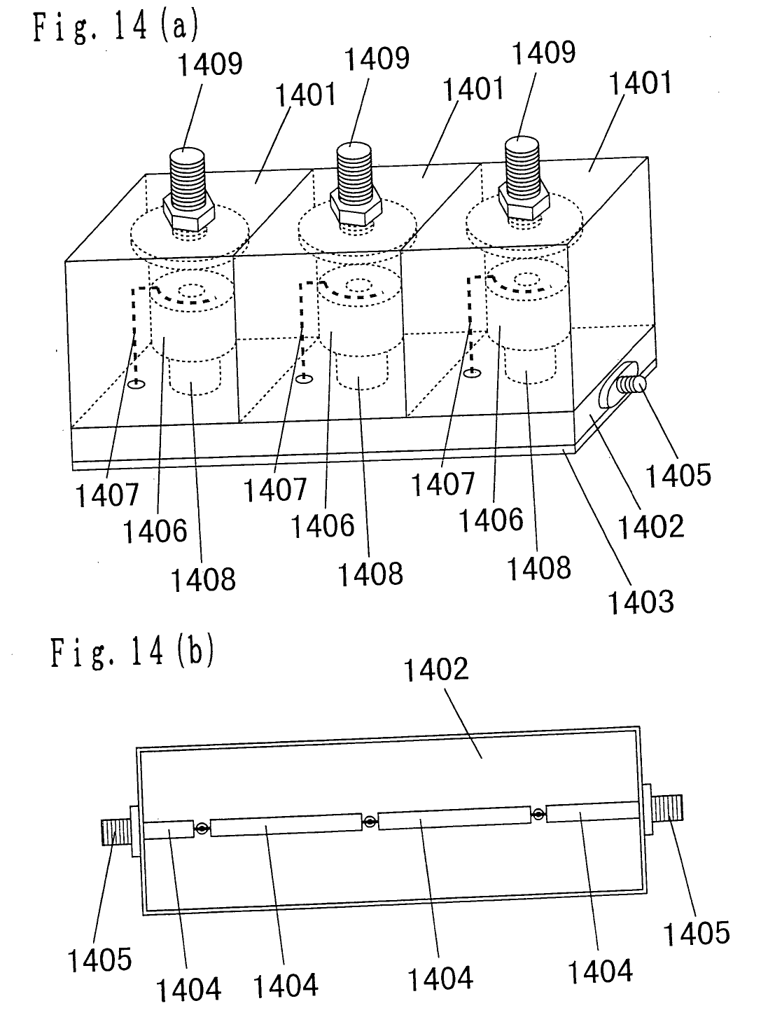

FIG. 13 shows an inter-stage cavity excluding partitions, a lid, and an input/output probe of the four-stage TE-mode band-pass filter of the embodiment 6. A portion same as that in FIG. 5 is provided with the same symbol. In FIG. 13, symbol 1301 denotes a dielectric-resonance-element holder, 1302 denotes dielectric-resonance-element-holder hardware. The dielectric-resonance-element holder 1301 is made of a low-dielectric-constant material having a high Q-value such as Teflon.

When a resonance frequency is low, a resonator increases in shape and weight. In this case, the mechanical strength of an adhesive becomes insufficient between an inter-stage support 105 and an inter-stage dielectric resonance element 107 and between the inter-stage support 105 and a case 101. Therefore, the dielectric resonance element 1301 provided with a protrusion having an outside diameter equal to or slightly smaller than the diameter of the internal hole of the inter-stage dielectric resonance element 107 is fitted to the inter-stage dielectric resonance element 107 and fixed by the dielectric-resonance-element-holder hardware 1302 fixed to the case 101 or partition 102 through soldering or the like. Thereby, it is possible to fix the inter-stage dielectric resonance element 107 and the earthquake resistance and filter stability are improved.

Moreover, even if the dielectric-resonance-element holder 1301 is not provided with a protrusion fitted with the internal hole of the inter-stage dielectric resonance element 107, it is possible to fix the inter-stage dielectric resonance element 107.

Furthermore, it is possible to apply the above fixing method not only to an inter-stage cavity but also to an input output-stage cavity.

(Embodiment 7)

Then, the embodiment 7 of the present invention is described below by referring to the accompanying drawings.

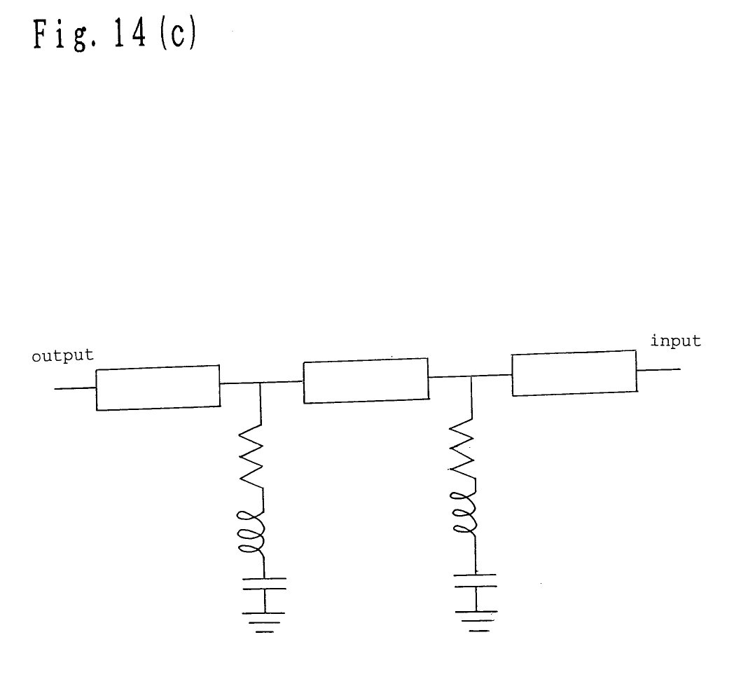

FIGS. 14(a) to 14(c) show the three-stage TE-mode band-pass filter of the embodiment 7, in which FIG. 14(a) is a perspective view, FIG. 14(b) is a bottom view, and FIG. 14(c) is a transmission circuit diagram. In FIGS. 14(a) to 14(c), symbol 1401 denotes a cavity, 1402 denotes a transmission line case, 1403 denotes a lid, 1404 denotes a transmission line, 1405 denotes an input/output port, 1406 denotes a dielectric resonance element, 1407 denotes an input/output probe, 1408 denotes a support, and 1409 denotes a tuning plate.

The transmission lines 1404 respectively have a length of approx. ¼ wavelength and are tandem connected. The input/output port 1405 is connected to the both ends of these transmission lines 1404. The transmission line case 1402 with extension of the transmission line 1404 is shielded with the lid 1403. One end of the input/output probe 1407 is connected between the transmission lines 1404 and then electromagnetic-field-couple with the dielectric resonance element 1406 set to almost the center of the cavity 1401 through the support 1408 in the cavity 1401.

The tuning plate 1409 is connected through the threading of the cavity 1401 to adjust a resonance frequency by making the tuning plate 1409 approach to or separate from the dielectric resonance element 1406.

Operations of the three-stage TE-mode band-pass filter constituted as described above are described below.

By connecting a series resonance circuit between the ¼-wavelength transmission lines 1404 in parallel, a band elimination filter is constituted (refer to FIG. 14(c)). A resonance frequency is decided in accordance with sizes of the dielectric resonance element 1406 and cavity 1401 and fine adjustment is performed by raising or lowering the tuning plate 1409. The width and depth of the attenuation characteristic of the band elimination filter is decided in accordance with the strength of the coupling between the input/output probe 1407 and dielectric resonance element 1406 and lengths of the ¼-wavelength transmission lines 1404 are fine-adjusted in accordance with matching of low-frequency-band side and high-frequency-band side of an attenuation pole in a desired frequency band to obtain a desired characteristic of the band elimination filter.

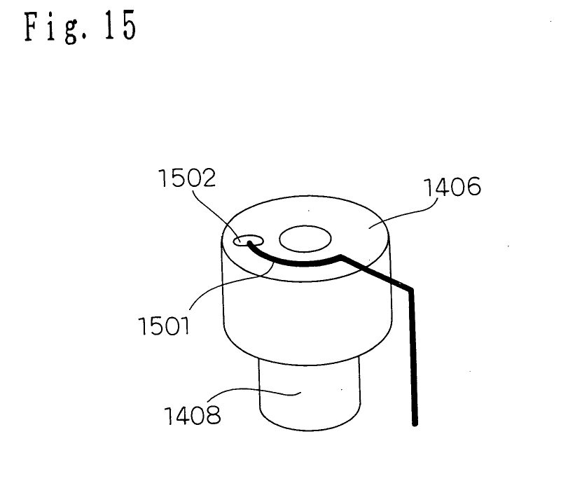

The input/output probe 1407 in FIG. 14 is set so as to become a circular arc concentric with the dielectric resonance element 1406 on the upper face of the dielectric resonance element 1406 the same as the case of the input/output probe 1501 in FIG. 15. Thereby, it is possible to strengthen the coupling. The front end of the input/output probe 1501 is fixed to the dielectric resonance element 1406 by an input/output-probe-fixing adhesive 1502 and thus, the earthquake resistance of the input/output probe 1501 and he stability of a filter are improved.

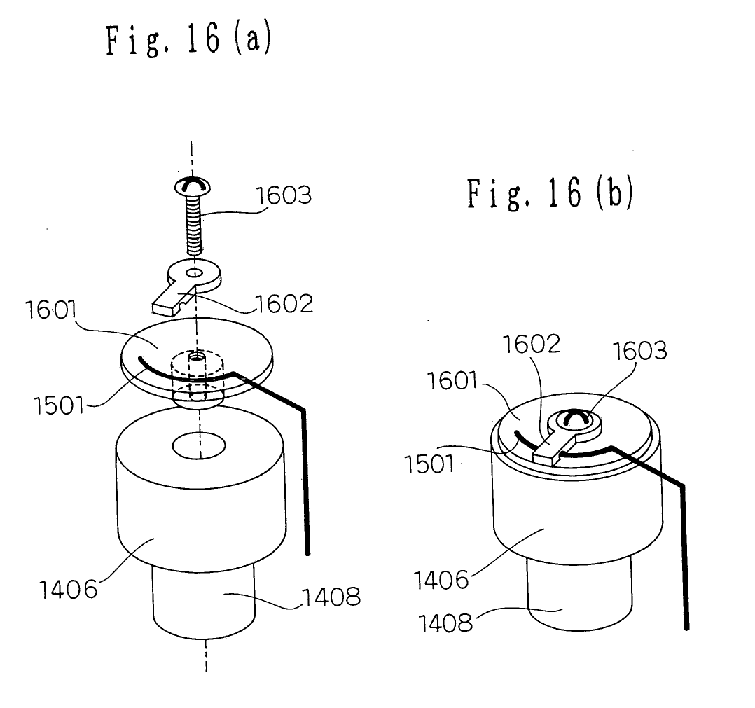

Even if fixing the input/output probe 1501 by a low-dielectric-constant material having a high Q-value such as Teflon or an insulating material as shown in FIG. 16, the same earthquake resistance and filter stability can be obtained. The protrusion of an input/output-probe support 1601 having a diameter equal to or slightly smaller than the diameter of the protrusion of the internal hole of the dielectric resonance element 1406 is fitted into the internal hole of the dielectric resonance element 1406.

In this case, the difference between the diameter of the internal hole of the dielectric resonance element 1406 and the outside diameter of the protrusion of the input/output-probe support 401 is minimized so that the input/output-probe support 1601 is not removed from the dielectric resonance element 1406. The input/output-probe support 1601 and input/output-probe holder 1602 are fixed by extending the input/output probe 1501 on the input/output-probe support 1601 and holding the input/output probe 1501 by the input/output probe holder 1602 from the top of the input/output probe 1501, and fixing the input/output-probe support 1601 and input/output-probe holder 1602 with a bolt 1603.

By using a nonmetallic material such as Teflon or plastic having a high Q-value as materials of the input/output-prove support 1601, input/output-probe holder 1602, and bolt 1603, it is possible to realize a small-loss filter in which the Q-value of a resonator is hardly deteriorated. Moreover, the input/output-probe support 1601 is tapped so that it can be fastened by the bolt 1603.

Though the input/output probe 1501 has been set on the dielectric resonance element 1406 clockwise, it is also allowed to set it counterclockwise.

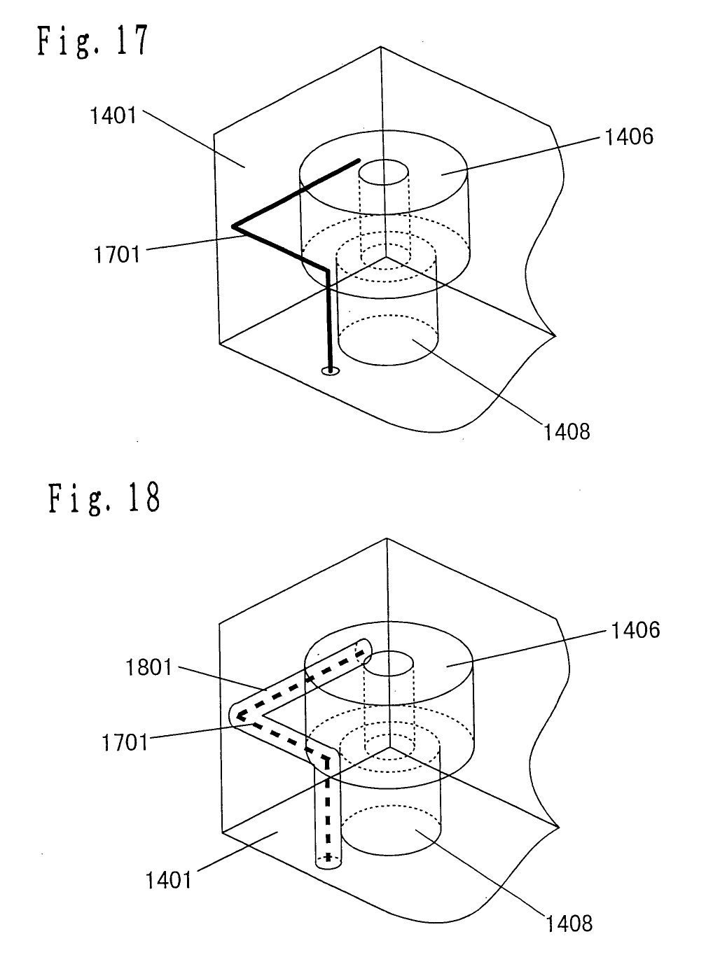

The input/output probe 1407 in FIG. 14 is formed into an L-shape along the case 1401 at the height of the dielectric resonance element 1406 nearby the center of the thickness of the element 1406 the same as the case of the input/output probe 1701 in FIG. 17. By forming the input/output probe 1701 into an L-shape, a capacity is formed between the case 1401, that is, the ground and the input/output probe 1701 and thereby, it is possible to strengthen the coupling with the input/output-stage dielectric resonance element 1406.

Moreover, as shown in FIG. 18, the input/output probe 1701 is covered with a low-dielectric-constant material having a high Q-value such as Teflon. Thus, by forming the input/output-probe coat 1801 between the input/output probe 1701 and the case 1401 serving as the ground, it is possible to prevent discharge breakdown when a high power is input.

Furthermore, though the input/output-prove coat 1801 surrounds the input/output probe 1701 in the case of this embodiment, it is also allowed to form the input/output-probe coat 1801 only between the input/output probe 1701 and the case 1401 serving as the ground.

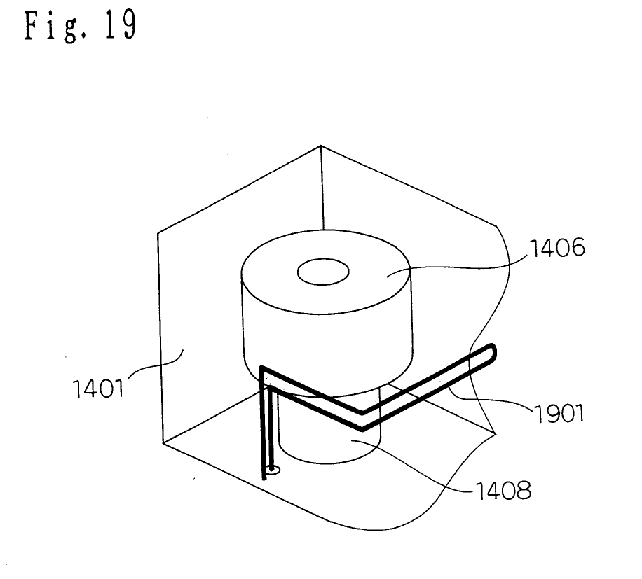

Similarly to the case of the input/output probe 1901 in FIG. 19, the front end of the input/output probe 1407 in FIG. 14 with the front end opened of the conventional example, embodiment 1, or embodiment 2 is short-circuited by almost doubling the length of the input/output probe, folding the front end of the input/output probe, and connecting the front end to the ground near the input/output port 109 so as to extend along the input/output port 109 and the input/output probe up to the folding portion. Thereby, the front end of an input/output probe on which current is most concentrated when a high power is input is rounded to prevent discharge breakdown.

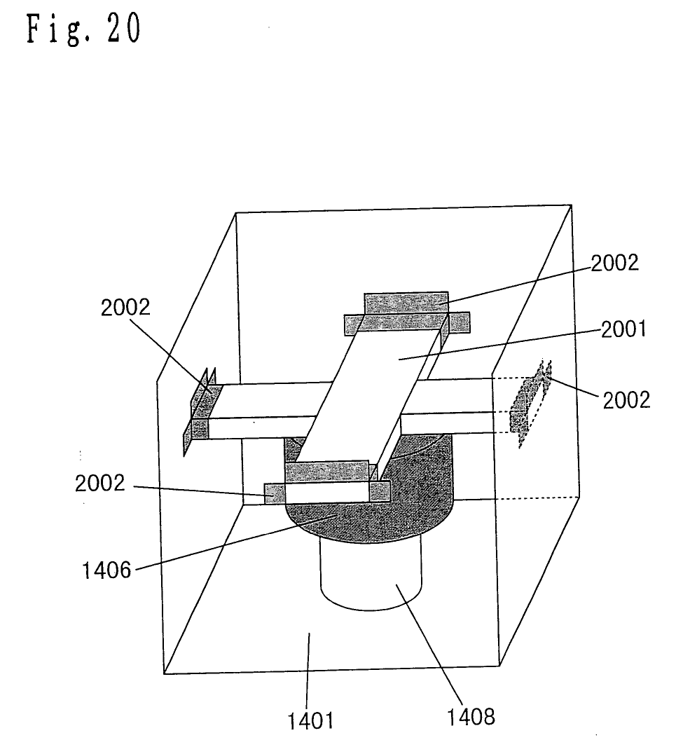

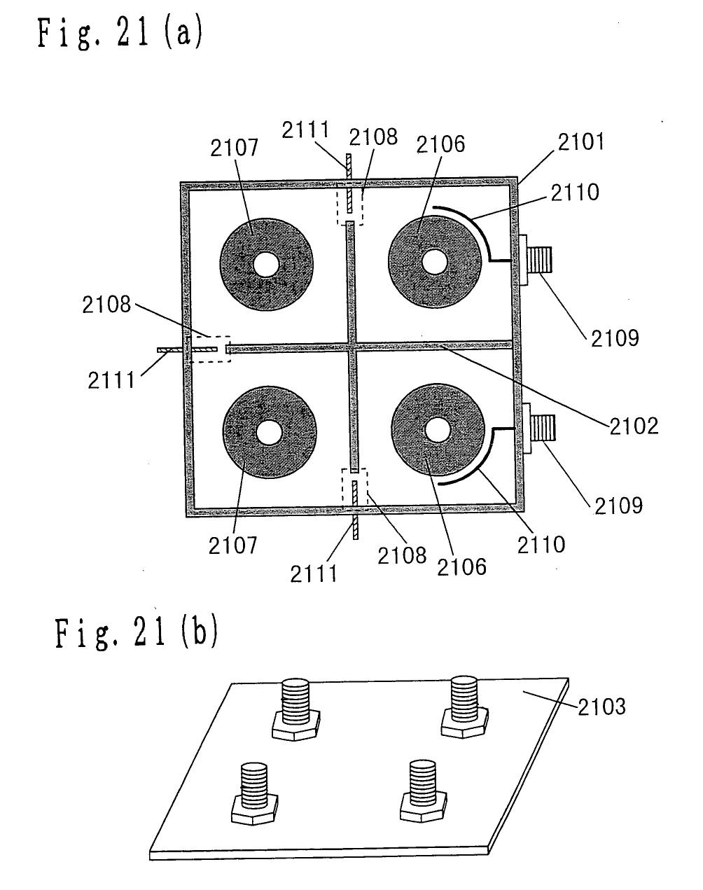

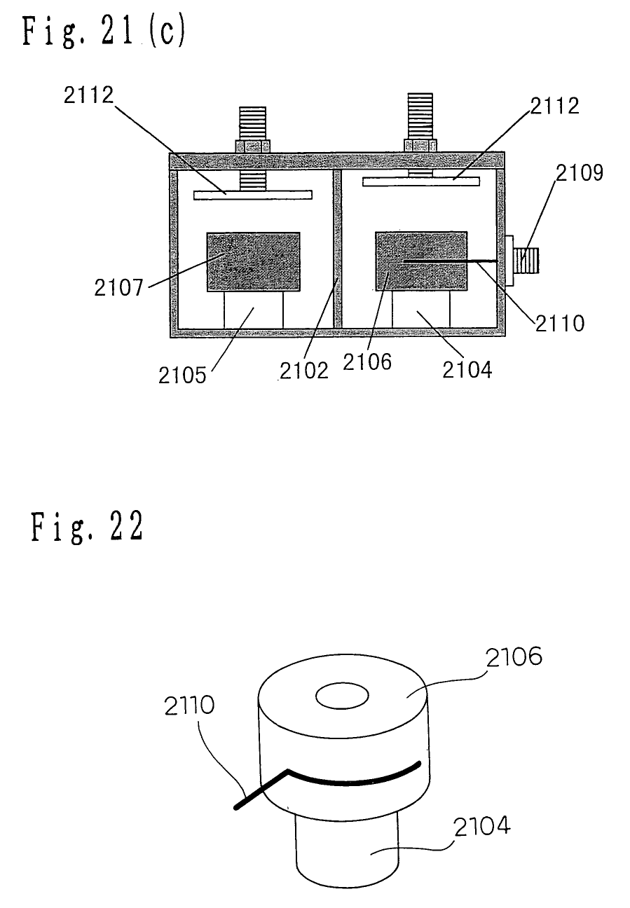

FIG. 20 shows a cavity between stages when removing the partition, lid, and input/output probe of the three-stage TE-mode band-pass filter of the embodiment 7. The dielectric resonance element 1406 in FIG. 14 is fixed by the dielectric-resonance-element holder 2001 and dielectric-resonance-element-holder hardware 2002 in FIG. 20. The dielectric-resonance-element holder 2001 is made of a low-dielectric-constant material having a high Q-value such as Teflon.

When a resonance frequency lowers, the shape of a resonator increases in size and weight. Then, the mechanical strength of an adhesive becomes insufficient between the support 1408 and dielectric resonance element 1406. Therefore, the dielectric-resonance-element holder 2001 having a protrusion whose outside diameter is equal to or slightly smaller than the diameter of the internal hole of the dielectric resonance element 1406 is fitted to the dielectric resonance element 1406 and fixed by the dielectric-resonance-element-holder hardware 2002 fixed to the case 1401 through soldering or the like. Thereby, it is possible to fix the dielectric resonance element 1406 and the earthquake resistance and filter stability are improved.

Even if the dielectric-resonance-element holder 2001 does not have a protrusion to be fitted into the internal hole of the dielectric resonance element 1406, it is possible to fix the dielectric resonance element 1406.

Moreover, the present invention is a transceiving system provided with the dielectric filter of the present invention described above, receiving circuit, transmitting circuit, and antenna.

Though the present invention uses a four-stage TE mode and a three-stage TE mode as examples in the case of the above embodiment, it is applicable to a filter of a TE mode of more than four stages or less than three stages such as one stage. FIG. 1(d) shows the case of one stage. In this case, an input probe is set on the upper face of a dielectric resonance element and an output probe is set on the lower face of the dielectric resonance element.

### INDUSTRIAL APPLICABILITY

As described above, the present invention can provide a dielectric filter for improving the coupling degree between an input/output probe and a dielectric resonance element.

Moreover, the present invention can provide a dielectric filter having a high earthquake resistance and stability of an input/output probe.

Furthermore, according to the present invention, by using a plurality of inter-stage adjustment screws, the number of adjustment portions is increased, the coupling adjustment width can be increased, and the adjustment time is reduced.

Furthermore, the present invention can provide a dielectric filter for decreasing the intensity of signal noises out of a desired frequency band.

Furthermore, the present invention can provide a dielectric filter capable of preventing discharge from easily occurring when a high power is input.

Furthermore, the present invention can provide a dielectric filter including a dielectric resonator having a high earthquake resistance and stability.

1. (amended) A dielectric filter comprising:
a dielectric resonator having a flat face;
an input/output probe electromagnetic-field-coupling with the dielectric resonator;
a metallic case for including the input/output probe and the dielectric resonator;
a lid; and
a tuning plate; wherein
the tuning plate and the flat face of the dielectric resonator are faced each other,
a part of the input/output probe is located between the dielectric resonator and the turning plate or between the metallic case at a portion of the dielectric resonator located at the opposite side to the turning plate and the dielectric resonator,
shapes of the dielectric resonators are cylindrical,
the flat faces of the cylindrical dielectric resonators and the tuning plate are faced each other, and
the shape of the input/output probe is a shape substantially along a predetermined concentric circular arc of the flat faces of the dielectric resonators.

2. A dielectric filter comprising:
a metallic case;
a lid;
a metallic partition for partitioning the inside of the metallic case into a plurality of spaces;
a plurality of dielectric resonators arranged in the partitioned spaces one each and respectively having a flat face;
a turning plate; and
an input/output probe; wherein
the tuning plate and the flat faces of the dielectric resonators are faced each other,
a part of the input/output probe is located between the dielectric resonators and the turning plate or between the metallic case at a portion of the dielectric resonators located at the opposite side to the turning plate and the dielectric resonators,
a coupling window is formed between the metallic case and the partition in a face substantially including the partition,
a coupling adjustment screw for fine-adjusting the coupling degree between adjacent dielectric resonators coupled through the coupling window is further included, and
a part of the coupling adjustment screw is located at the coupling window.

3. (Deleted)

4. (Deleted)

5. (Amended) The dielectric filter according to any one of claims 1 to 2, wherein
the input/output probe is mechanically fixed to the dielectric resonators on the flat faces of them.

6. (Amended) A dielectric filter comprising:
a metallic case;
a lid;
a metallic partition for partitioning the inside of the metallic case into a plurality of spaces;
a plurality of dielectric resonators arranged in the partitioned spaces and respectively having a flat face;
a tuning plate;
an input/output probe; and
a plurality of transmission lines connected in series between an input terminal and an output terminal; wherein
the tuning plate and the flat faces of the dielectric resonators are faced each other,
a part of the input/output probe is located between the dielectric resonators and the tuning plate or between the metallic case at a portion of the dielectric resonators located at the opposite side to the tuning plate and the dielectric resonators,
one end of the input/output probe is connected to each connection point of the plurality of transmission lines, and
the other end of the input/output probe is fixed to the flat faces of the dielectric resonators by an insulating adhesive.

7. The dielectric filter according to claim 5, comprising:
a flat input/output-probe support formed by a low-dielectric-constant material or insulating material and having a cylindrical protrusion; and
an input/output-probe holder formed by a low-dielectric-constant material or insulating material; wherein
the dielectric resonators are respectively provided with an internal hole into which the protrusion is fitted, and
the input/output probe is held and fixed by the input/output-probe support fixed by the protrusion being fitted into the internal hole of each of the dielectric resonators and the input/output-probe holder.

8. A dielectric filter comprising:
an input/output probe;
a dielectric resonator; and
a metallic case including the input/output probe and the dielectric resonator; wherein
at least a part of the input/output probe is mechanically fixed to the dielectric resonator.

9. A dielectric filter comprising:
a metallic case;
a lid;
a metallic partition for partitioning the inside of the metallic case into a plurality of spaces;
a plurality of dielectric resonators arranged in the partitioned spaces; and
an input/output probe; wherein
a coupling window is formed between the metallic case and the partition in a face substantially including the partition,
a coupling adjustment screw for fine-adjusting the coupling degree between the adjacent dielectric resonators coupled through the coupling window is further included, and
a part of the coupling adjustment screw is located at the coupling window and moreover, the top of the coupling adjustment screw is covered with a low-dielectric-constant material.

10. The dielectric filter according to claim 9, wherein
a plurality of the coupling adjustment screw s are used.

11. (Amended) A dielectric filter comprising:
an input/output probe;
a dielectric resonator; and
a metallic case including the input/output probe and the dielectric resonator; wherein
at least a part of the input/output probe is separated from the metallic case by a substantially equal distance
the dielectric resonator has two flat faces opposite to each other, and
the position of the input/output probe is present at the lateral side of the dielectric resonator between lower flat face and the upper flat face of the dielectric resonator.

12. (Amended) A dielectric filter comprising:
a metallic case;
a metallic partition for partitioning the inside of the metallic case into a plurality of spaces;
a plurality of dielectric resonators arranged in the partitioned spaces; and
an input/output probe; wherein
at least a part of the input/output probe is separated from the partition by a substantially equal distance, and
the position of the input/output probe is present at the lateral side of the dielectric resonator between lower flat face and the upper flat face of the dielectric resonator.

13. The dielectric filter according to claim 11 or 12, wherein
a member formed by a low-dielectric-constant material is provided between the input/output probe and the metallic case or between the input/output probe and the partition.

14. The dielectric filter according to claim 11 or 12, wherein
a portion of the input/output probe separated from the metallic case by a substantially equal distance or a portion of the input/output probe separated from the partition by a substantially equal distance is covered with a low-dielectric-constant material.

15. The dielectric filter according to claim 11 or 12, wherein
the front end of the input/output probe is folded like a loop.

16. The dielectric filter according to claim 11 or 12, wherein
the front end of the input/output probe is rounded through soldering.

17. The dielectric filter according to claim 11 or 12, wherein
the front end of the input/output probe is covered with a cap made of a low-dielectric-constant material.

18. A dielectric filter comprising:
an input/output port;
an input/output probe;
a dielectric resonator; and
a metallic case including the input/output probe and the dielectric resonator; wherein
the input/output probe is formed by two metal wires arranged so that the input/output probe keeps a substantially parallel relation,
front ends of the two metal wires are connected so as to be rounded, and
one of the two metal wires is connected with the input/output port and the other of them is grounded to the metallic case.

19. (Amended) A dielectric filter comprising:
an input/output probe;
a dielectric resonator;
a dielectric-resonator support for supporting the dielectric resonator;
a dielectric-resonator-fixing member for fixing the dielectric resonator formed by a low-dielectric-constant material; and
a metallic case including the input/output probe and the dielectric resonator, wherein
the lower face of the dielectric resonator connects with the metallic case through the dielectric-resonator support, and
the dielectric-resonance is fixed to the upper face of the dielectric resonator by the dielectric-resonator-fixing member.

20. The dielectric filter according to claim 19, wherein the dielectric-resonator-fixing member is constituted by two support rods arranged so as to form a cross on the upper face of the dielectric resonator and four support-rod holders for fixing the both ends of the support rods to the metallic case.

21. The dielectric filter according to claim 20, wherein
the dielectric resonator has a predetermined internal hole, and
one of the support rods has a protrusion fitted into the internal hole and the protrusion is fitted into the internal hole and the above one support rod is integrated with the dielectric resonator.

22. (Amended) A transceiving system comprising:
the dielectric filter of any one of claims 1, 2 and 5 to 21;
a receiving circuit;
a transmitting circuit; and
an antenna.
